(19) United States
(12) Patent Application Publication
(10) Pub. No.: US 2006/0011314 A1
(43) Pub. Date: Jan. 19, 2006

(54) Process for pulping waste paper containing impurities

(76) Inventors: Erwin Hertl, Judendorf (AT); Peter Sket, Gratkorn (AT)

Correspondence Address: Alix, Yale & Ristas, LLP, 750 Main Street, Hartford, CT, 06103, US

(21) Appl. No.: 11/181,052

(22) Filed: Jul. 14, 2005

(30) Foreign Application Priority Data
Jul. 16, 2004 (AT) A 1212/2004

(51) Int. Cl. D21B 1/08; B01D 37/00; D21C 5/02

(52) U.S. Cl. 162/4; 162/6; 210/770

(57) ABSTRACT

The invention relates to a process for pulping waste paper containing impurities, used in the production of paper and board, with a feed device, a dewiring unit, and a pulping section. In order to improve pulping and thus generate less non-screenable impurities, which would make it possible to use larger proportions of waste paper with water-soluble inks, a liquid penetration stage is included in the process before pulping.

### BACKGROUND OF THE INVENTION

The invention relates to a process for pulping waste paper containing impurities, used in the production of paper and board, with a feed device, a dewiring unit, and a pulping section.

Due to the rising amount of printed matter, mainly printed using water-soluble ink, some adjustments are needed to the recycling process and to repulping in the deinking process. For the recycling process, this input of water-soluble printing inks creates a problem because the printing inks behave differently in the suspension and, in some cases, can no longer be removed from a suspension at all. Furthermore, the removal of adhesives and other impurities from the waste paper will gain more and more importance in deinking processes in the future, and according to current knowledge, the efficiency of this process can only really be improved to the required extent by making technological changes to the pulping process. Here, it is important to remove the impurities mentioned in such a way that the yield losses do not increase further compared with a state-of-the-art deinking plant.

The processes known today operate according to the principle of fiberizing the waste paper and detaching all printing inks from the fibers in the alkaline (addition of caustic soda, sodium silicate or hydrogen peroxide, etc.) or neutral pH range (no or other chemicals, in waste paper pulping, etc.), and then removing them from the suspension by flotation and/or washing.

The disadvantage here, however, is that the water added when pulping the waste paper causes the binding agents in the water-soluble printing inks to be distributed partly or entirely through the water (dispersion and/or solution) or to form a solution. The printing ink particles or ink residues released in this process are either too small or completely dissolved, which means they cannot be removed efficiently enough by means of flotation. As a result, these printing ink particles are removed by pulp washing and/or the neutral process mode, however this has the disadvantage of higher solids losses. A further disadvantage of this process is the fact that the waste paper is fed to the waste paper pulping process in its original form and thus, requires high energy densities for pulping. The disadvantage of these high energy densities in waste paper pulping is that the impurities contained in the waste paper are also greatly reduced in size, making them more difficult to remove in the machines and systems in the deinking plant that follows.

A common pulping plant, in which the problems mentioned here related to the treatment of waste paper with water-soluble printing ink are particularly prominent, is described in EP 1 170417 A1 (VOITH). In DE 3332389 A1 (Dollard Karton), a process is described in which a soaking drum precedes the pulper. Here, too, there is still a problem with the high energy density required for pulping, as well as with the poor separability when used for waste paper with water-soluble printing ink.

The invention is now intended to reduce or entirely eliminate the problems of the existing processes. Cleaning effect and yield should be improved, particularly when used for waste paper with water-soluble printing ink.

### SUMMARY OF THE INVENTION

The invention is thus characterized by a penetration stage being included before pulping. Penetration relates on the one hand to detaching of the water-soluble printing ink particles from the waste paper pulp, as well as denoting the permeation of liquid, i.e. water and/or chemicals, into the pieces of waste paper. In this process stage, the water-soluble printing inks are detached from the fibers, fillers or coating pigments and dispersed in the aqueous transport agent. The non water-soluble printing inks remain unchanged on the fiber, filler and coating pigments, as do the fines and ash particles, in this process stage. The pieces of paper largely retain their morphology. Fines and ash remain in the pieces of paper instead of passing into the aqueous phase in the form of a dispersion. As a result, it is possible in the following process phases to separate these printing ink dispersions from the aqueous phase and remove them from the deinking system in a way that retains ash and fines.

An advantageous development of the invention is characterized by water being added for penetration purposes, although it is also possible to add chemicals, such as caustic soda, sodium silicate, hydrogen peroxide, complexing agent and soap and/or tenside to the penetration stage. By adding water and/or chemicals, the detaching and penetration process stages can be controlled and optimized effectively.

It is a particular advantage if a shredding stage is provided for the dry material (waste paper) upstream of the penetration stage. If the pieces of paper are shredded, the time it takes for the water to penetrate into the waste paper is shortened and, as a result, so is the time required to pulp the waste paper, which in turn leads to a reduction in specific energy input in the pulping stage. Although the impurities are also reduced in size to some extent in the shredding process, better overall pulp quality is achieved due to the resulting reduction in energy input to the waste paper pulping process.

It has proved a particular advantage to include a heavy matter separator after the shredding stage, for example an air cleaner. By doing so, the equipment in the subsequent process stages is protected against wear. This separation stage for heavy matter removes all heavy items, such as steel, iron, coarse sand, plastic, and other coarse impurities.

A favorable embodiment of the invention is characterized by the solid/liquid mixture being dewatered or thickened after the penetration stage, and the water containing impurities possibly being fed to a water treatment stage, for example filtration. The ink particles or dyes finely dispersed or dissolved in the water can thus be transferred from the water to the sludge produced in a further process step of a water treatment stage, e.g. fixed bed filtration, nano, ultra, or fine filtration, reverse osmosis, cleaner, decanter/centrifuges, or also a combination of these units with or without added chemicals, such as dispergators, agglomerators, flocculants, fiocculant additives, precipitating agents, and combinations thereof.

It has proved an advantage if the cleaned water is added again to the penetration stage.

### BRIEF DESCRIPTION OF THE DRAWINGS

The invention will now be described in examples and referring to the drawings, where

FIG. 1 shows the state-of-the-art process in a diagram;

FIG. 2 shows a variant of the invention; and

FIG. 3 shows a further variant of the invention.

### DESCRIPTION OF THE PREFERRED EMBODIMENT

In a conventional system the waste paper as delivered is printed both with water-soluble and with non water-soluble inks. Water-soluble inks consist mainly of inorganic and organic dyes and pigments, as well as other additives, such as binding agents. These binding agents can be dispersed or dissolved in water under certain chemical and/or physical conditions. The pigments and additives are then present as very fine particles that are dispersed or, in some cases, completely dissolved in water. These particles are too small to be removed in deinking flotation. The fully dissolved and/or dispersed dye components create problems because of their inherent color in a state-of-the-art deinking plant, which requires low fines, ash and fiber losses. The final quality—particularly the brightness and whiteness, as well as the chromaticity coordinate—suffers negative influence as a result.

Non water-soluble printing inks can be removed in a standard deinking process that is state of the art. This process will not be discussed in any further detail here. Stickies and impurities (all types of substance that spoil the final product of the deinking process) are undesirable components in the waste paper supplied to the deinking plant and consist of organic and/or inorganic components or a combination of both, which have to be added to the original paper product for production and delivery to the final customer (newspaper, advertising material, etc.) or which have entered the deinking plant as an impurity in the course of waste paper recycling. Stickies and impurities upset the deinking process in any event and have a negative influence on the quality of its final product and on the running properties of the paper machine.

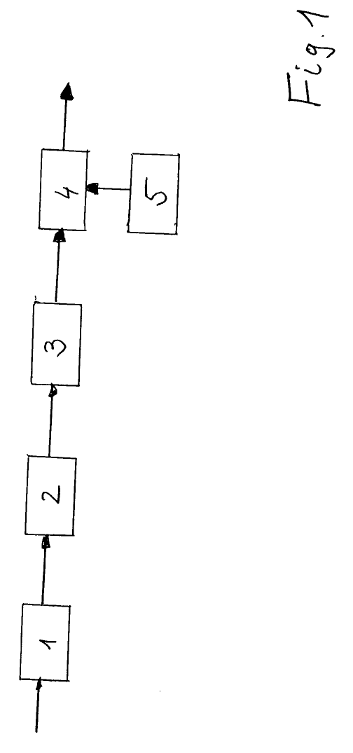

FIG. 1 illustrates a state-of-the-art pulping process. It consists of a feed system 2, where the waste paper 1 is dewired 3 and fed in loose, bale, or any other form to the waste paper pulping stage 4. Waste paper pulping 4 is normally performed with added water 5 in a pulp consistency range of 3 to 30% and at a temperature of 30 to 80° C., continuously or in batch operation, in pulpers, pulping drums, or a combination of the two. The reject is disposed of by a separate disposal system, through which the entire pulp flow or a part flow thereof is fed in order to remove the reject and discharge it from the system. Chemicals, such as caustic soda, sodium silicate, hydrogen peroxide, complexing agents and soap and/or tenside or other additives that benefit the process are added to the waste paper pulping system. After the waste paper pulping process, the fiberized waste paper pulp is fed to a further treatment stage which will not be discussed here in further detail.

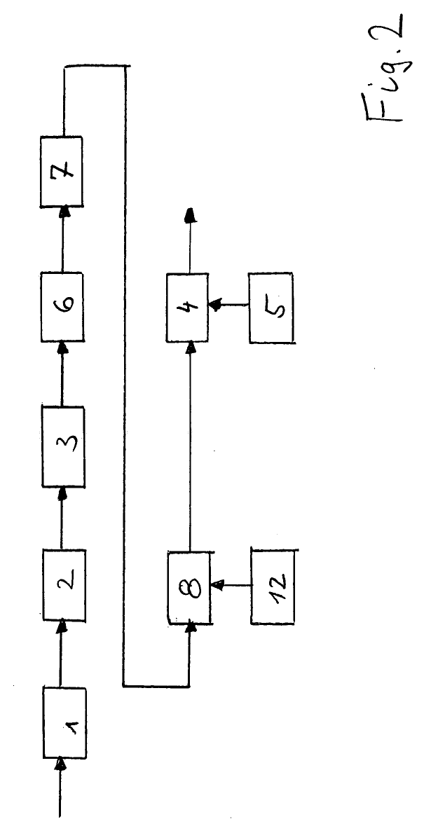

In FIG. 2, a process is described using waste paper of a quality that is usual nowadays and which contains a proportion of waste paper printed with water-soluble inks, as is treated in standard deinking plants according to current standards, where the water-soluble ink content must not exceed—the level that can be treated in a standard deinking plant with the qualities and yields obtainable today. The process is also used in waste paper pulping plants, where every possible composition of waste paper, particularly also printed or unprinted board, is used. The process comprises a feed system 2 and a dewiring system 3, a shredding stage 6 and a heavy matter removal stage 7 preceding the detaching and penetration stage 8, which is followed by the waste paper pulping stage 4. This system is used to pulp and clean waste paper comprising the usual waste paper qualities obtained with state of the art technology.

The system largely consists of a shredding stage 6, where the waste paper supplied is reduced in size as required, e.g. by using a shredder or a chopper, etc. in order to increase the effective surface area of the waste paper for the subsequent process stages, which are detaching and permeation 8, and waste paper pulping 4, and thus substantially increase the water penetration and waste paper pulping speed. Even when shredded, the waste paper is in essence small webs of interengaged fibers and/or pulp. The penetration of fluid at 8 dissolves water soluble inks and presoaks the waste paper to improve efficiency in the subsequent pulping stage. As mechanical protection for the subsequent machines and systems, a heavy matter separating system 7, e.g. an air cleaner, follows the shredding stage. In the subsequent penetration stage 8, which can be, for example, a displacement washing stage, a soaking tank, a dewatering drum, etc., the required quantity of water, e.g. for a consistency of 1-60%, is added at the required temperature, e.g. 30-80° C., and pH-value, e.g. 5-10, etc. in order to penetrate the dry waste paper with water and with or without chemicals, as required, in such a way as to make the pulping process 4 more beneficial in terms of non-pulping and non-dispersing of impurities. The reason for this is the chemical and physical conditions prevailing during detaching in the detaching and permeation stage 8, as well as the fact that only small amounts of mechanical energy are channeled into the pulping system, compared to the waste paper pulping stage, after the pieces of paper come into contact with the water and/or chemicals (such as caustic soda, sodium silicate and hydrogen peroxide, agglomerators, dispergators, soaps, tensides, flocculants and precipitating agents, etc., or combinations thereof). Shredding and penetration in the detaching and penetration stage 8 is an advantage for the subsequent waste paper pulping stage 4, which then requires substantially lower energy input and/or lower waste paper pulping temperatures and, if applicable, lower ph-values due to the paper being easier to fiberize and the printing ink particles being easier to detach from the fibers, fillers, and coating pigments in the pieces of paper that have already been penetrated. This also results in smaller waste paper pulping machines.

Due to this improvement in process conditions for the waste paper pulping stage 4, far fewer macrostickies (screenable form of stickies) and stickies (larger than macrostickies) are dispersed or dissolved. Thus, screening with the subsequent coarse, MC-fine, and/or LC-fine screens is much more effective than it is in the state-of-the-art deinking process. After the required residence or retention time of approximate 1 to 120 minutes in the detaching system 8, the pieces of paper are transferred to the pulping system 4, where the actual pulping or fiberizing process takes place. Here, water is added to this waste paper pulping stage 4 in the required quantity and quality, and at the required temperature and pH-value, etc. In addition, optimization and setting of the physical (e.g. temperature, etc.) and chemical parameters (additives, such as caustic soda, sodium silicate and hydrogen peroxide, agglomerators, dispergators, soaps, tensides, fiocculants and precipitating agents, etc., or combinations thereof) can further improve this waste paper pulping process 4 if required.

The further treatment process after waste paper pulping is conducted according to the known state of the art and will not be discussed any further here.

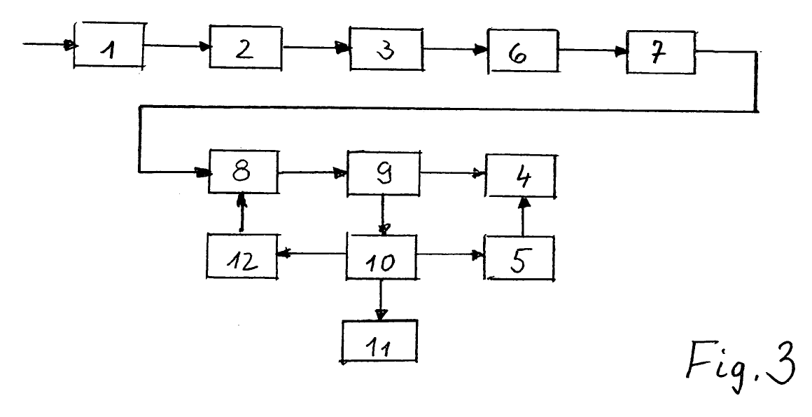

FIG. 3 describes the way in which the feed system 2 and the dewiring system 3 are followed by the shredding stage 6 upstream of the heavy matter removing stage 7, which precede the detaching and penetration stage 8, where this stage is followed by the separation stage 9 and then the waste paper pulping stage 4. The waste paper used can contain up to 100%, particularly favorable from 5% upwards, waste paper printed with water-soluble printing inks. Part of this system was already described in its essence in connection with FIG. 2.

Since the pieces of paper retain their morphology and the fines and ash remain in the piece of paper, these substances are not transferred to the aqueous phase as a dispersion. As a result, it is possible in the subsequent process stages to remove these printing ink dispersions from the aqueous phase and discharge them from the deinking system in a way that allows retention of ash and fines.

After penetration in the detaching and penetration stage 8 for the required residence or retention time of approximately 1 to 120 minutes, the pieces of paper and the liquid are separated from one another in the separation stage 9, e.g. displacement washing and/or washer/thickener or thickener. The printing ink particles or dye finely dispersed or dissolved in the water can thus be transferred from the water to the sludge 11 produced in a further process step in a water treatment stage 10, e.g. fixed bed filtration, nano, ultra, or fine filtration, reverse osmosis, cleaner, decanter/centrifuges, or other machines, also in combinations of these units, with chemicals added if required, such as dispergators, agglomerators, fiocculants, fiocculant additives, precipitating agents, and combinations thereof. In this water treatment stage 10, the water is cleaned in such a way that it can be used again in the detaching and penetration stage 8, where it is mixed with fresh water at 12 and the appropriate parameters (temperature, pH-value, added chemicals) are set. The pieces of paper dewatered to between 5 and 60% in the separation stage 9 are fed to the pulping stage 4, where further treatment is effected in a state-of-the-art deinking line. With this process, waste paper with a high content of paper printed with water-soluble printing inks can be used without further losses in quality and yield compared with state-of-the-art technology.

Further improvements in the overall deinking process due to the effect of the invention on the subsequent systems and machines include higher final brightnesses. At the moment there is always an unknown content of non-deinkable waste paper printed with water-soluble printing inks in the overall waste paper input, whose effect on the final quality produced has not yet been quantified and for which there is still no method of measuring their content in the waste paper. Further advantages, as already mentioned in describing the system according to FIG. 2, include greater efficiency in removal of stickies, higher yields, and possible omission and/or reduction in the size of subsequent systems or machines.

1. Process for pulping waste paper containing impurities, used in the production of paper and board, with a feed device, a dewiring unit, and a pulping section, characterized by a liquid penetration stage being included before pulping.

2. Process according to claim 1, characterized in that the liquid includes water for penetration.

3. Process according to claim 1, characterized by chemicals being added to the penetration stage, e.g. caustic soda, sodium silicate, hydrogen peroxide, complexing agent and soap and/or tenside.

4. Process according to claim 1, characterized by a shredding stage being provided for the dry material upstream of the penetration stage.

5. Process according to claim 4, characterized by a heavy matter separator, for example an air cleaner, being included after the shredding stage.

6. Process according to claim 1, characterized by the solid/liquid mixture being dewatered or thickened after the penetration stage.

7. Process according to claim 6, characterized by the water containing impurities being fed to a water treatment stage, for example filtration.

8. Process according to claim 7, characterized by the cleaned water being added again to the penetration stage.

9. Process according to claim 2, characterized by a shredding stage being provided for the dry material upstream of the penetration stage.

10. Process according to claim 1, wherein the waste paper contains water soluble ink impurity, characterized by an aqueous penetration liquid that dissolves the water soluble ink and permeates the waste paper.

11. Process according to claim 10, characterized by chemicals being added to the penetration stage, e.g. caustic soda, sodium silicate, hydrogen peroxide, complexing agent and soap and/or tenside.

12. Process according to claim 11, characterized by a shredding stage being provided for the dry material upstream of the penetration stage.

13. Process according to claim 12, characterized by a shredding stage being provided for the dry material upstream of the penetration stage.

14. Process according to claim 13, characterized by the solid/liquid mixture being dewatered or thickened after the penetration stage.
